(19) United States
(12) Patent Application Publication
(10) Pub. No.: US 2025/0196659 A1
(43) Pub. Date: Jun. 19, 2025

(54) METHOD OF CONTROL FOR A VEHICLE, COMPUTER PROGRAM AND/OR COMPUTER-READABLE MEDIUM, CONTROLLER, AND VEHICLE, IN PARTICULAR COMMERCIAL VEHICLE

(71) Applicant: ZF CV Systems Global GmbH, Bern (CH)

(72) Inventors: Thomas Kattenberg, Vechelde (DE); Johannes Heseding, Hannover (DE); Andreas Marx, Seelze (DE)

(21) Appl. No.: 19/065,790

(22) Filed: Feb. 27, 2025

Related U.S. Application Data
(63) Continuation of application No. PCT/EP2023/074608, filed on Sep. 7, 2023.

(30) Foreign Application Priority Data
Sep. 14, 2022 (DE) 10 2022 123 507.6

(51) Int. Cl. B60L 15/20; B60L 3/10; B60W 10/08; B60W 10/18

(52) U.S. Cl. CPC B60L 15/2009; B60L 3/10; B60W 10/08; B60W 10/18; B60L 2240/423

(57) ABSTRACT

A method is for controlling a vehicle, in particular a commercial vehicle, having an electric drive, which has been configured for regenerative braking, and a friction-brake device. The method includes: capturing selection information; ascertaining a set of trigger thresholds and a slip-control method on the basis of the selection information, wherein the set of trigger thresholds includes one or more threshold-value conditions defined for the purpose of detecting the wheel-locking tendency; detecting a wheel-locking tendency on the basis of the one or more threshold-value conditions; and instigating a control of the electric drive and/or of the friction-brake device on the basis of the slip-control method and the set of trigger thresholds when the wheel-locking tendency has been detected.

### CROSS-REFERENCE TO RELATED APPLICATIONS

This application is a continuation application of international patent application PCT/EP2023/074608, filed Sep. 7, 2023, designating the United States and claiming priority from German application 10 2022 123 507.6, filed Sep. 14, 2022, and the entire content of both applications is incorporated herein by reference.

### TECHNICAL FIELD

The disclosure relates to a method of control for a vehicle, in particular a commercial vehicle, having an electric drive, which has been configured for regenerative braking, and a friction-brake device. The disclosure also relates to a computer program and/or computer-readable medium, to a controller for a vehicle, in particular a commercial vehicle, and to a vehicle, in particular a commercial vehicle.

The disclosure relates, in particular, to the field of vehicles—in particular, commercial vehicles, including trailers—having an electronically controlled braking system (electronic braking system, EBS, or trailer electronic braking system, TEBS) and at least one axle that is capable of being driven electrically by an electric drive (eDrive) via a central drive and/or a wheel-specific drive, the electric drive having been configured for regenerative braking. In other words, the electric drive can be operated as a wear-free continuous service brake, and in the event of a deceleration makes possible, in addition, a recovery of braking energy in the form of electrical energy (recuperation).

### BACKGROUND

During a braking procedure, or deceleration procedure, the electric drive can be operated on a driven axle for the purpose of braking, and the friction brake can be operated separately or jointly in each instance. If a braking torque achieved thereby results in an excessive slip or in a wheel-locking tendency, the overall braking torque resulting from a frictional braking torque and/or from a regenerative braking torque has to be reduced for the purpose of guaranteeing stability.

In braking systems according to the prior art, fixed trigger thresholds for detecting the wheel-locking tendency have been stored for anti-lock braking systems (ABS). These ABS trigger thresholds have been chosen in such a manner that the desired performance arises for the ABS control with a pneumatic braking system according to the prior art.

In braking systems according to the prior art, various thresholds are used within the scope of the ABS detection and ABS control. These thresholds are hard-coded and, in combination with input data, are adapted to the driving situation during operation. For instance, a shifting of the thresholds is undertaken on the basis of a detected coefficient of friction, and/or a curve correction is undertaken on the basis of the wheel slip. The threshold values include a maximally permissible wheel slip, a first threshold value for the wheel deceleration, above which a wheel-locking tendency is detected and the pressure is reduced, a second threshold value for the wheel deceleration, starting from which the pressure is maintained (the wheel deceleration decreases again), and a third threshold value for the (positive) wheel acceleration close to zero, which indicates the approach to the reference speed and initiates the phase of the build-up of pressure. The dynamics of the pneumatic brake with respect to reaction-times in the reduction and build-up of pressure is taken into account indirectly in the choice of the trigger thresholds. When a wheel-locking tendency has been detected, as a rule any existing and activated continuous service brake and/or regenerative brake is released, or deactivated, at the same time.

In the case of active ABS control, brake pressure is consequently reduced, maintained, and built up again cyclically, so that the wheel deceleration, or wheel acceleration, oscillates between the established thresholds. In parallel, existing continuous service brakes are deactivated, for instance via TSC1 messages, so that the ABS control is undertaken exclusively using the pneumatic braking system, or using the friction-brake device.

In this context, an electric drive is handled in a manner analogous to a conventional retarder and, according to the prior art, is released in the course of an ABS control. The application of the permanently stored, conservatively chosen ABS control thresholds has the consequence that the electric drive is released prematurely. As a result, recuperation potential is wasted, and the electric drive cannot be used actively for adjusting the slip and/or for braking.

DE 10 2019 135 087 A1 discloses a method for slip control of a vehicle wheel propelled with the aid of an electric drive, having at least the following steps: triggering of the electric drive of the vehicle wheel with an actual drive torque in a torque control in a torque-control step, ascertainment of a wheel speed and of a wheel slip of the vehicle wheel, and evaluation of the wheel slip via an instability criterion as to whether an instability obtains, direct or indirect transition into a control of the wheel slip to a target slip by triggering of the electric drive upon detection of an instability, ascertainment of whether an end-criterion for terminating the slip control has been satisfied, return to the torque control in the torque-control step if the end-criterion has been satisfied.

DE 10 2012 217 679 A1 discloses a slip-controlled braking system for an electrically powered motor vehicle, which includes friction brakes on the wheels of at least one axle, which are actuated by a friction-brake control device, at least one electric machine which is connected to at least one wheel and is actuated by an electric-drive control device, means for capturing a deceleration requirement, in particular a brake pedal with pedal-angle sensor, a wheel-slip control device and a torque-distribution device. The means for capturing a deceleration requirement are connected to the wheel-slip control device which specifies target braking torques for each wheel in accordance with the deceleration requirement, the wheel-slip control device being connected to a torque-distribution device which is connected to the friction-brake control device and to the electric-drive control device and which specifies, in accordance with the target braking torques, frictional braking requirements to the friction-brake control device and generator braking requirements to the electric-drive control device. Further information relating to the vehicle dynamics is communicated to the wheel-slip control device by a state-monitor. The electric-drive control device sends the currently applied generator braking torque(s) and/or the generator braking torque(s) that are/is capable of being generated maximally to the torque-distribution device, and the apportionment between frictional braking requirements and generator braking requirement(s) is undertaken, taking into account the generator braking torque(s) that is/are currently applied and/or capable of being generated maximally.

### SUMMARY

It is an object of the disclosure is to enrich the state of the art and to make possible an improved control system for braking a vehicle. In a configuration of the disclosure, the object may be that the electric drive is able to participate effectively in the braking of the vehicle, and possibilities for recuperation of energy can be exploited better.

The aforementioned object is, for example, achieved by virtue of various methods according to the disclosure and by various control devices according to the disclosure, various computer programs according to the disclosure, various computer readable mediums according to the disclosure, and various vehicles according to the disclosure.

According to the disclosure, a method of control is provided for a vehicle, in particular a commercial vehicle, having an electric drive, which has been configured for regenerative braking, and a friction-brake device. This method features: capturing selection information; ascertaining a set of trigger thresholds and a slip-control method on the basis of the selection information, the set of trigger thresholds including one or more threshold-value conditions defined for the purpose of detecting a wheel-locking tendency; detecting the wheel-locking tendency on the basis of the one or more threshold-value conditions; and instigating a control of the electric drive and/or of the friction-brake device on the basis of the slip-control method and the set of trigger thresholds when a wheel-locking tendency has been detected.

The vehicle, in particular the commercial vehicle, will be designated in the following as “vehicle”. The vehicle includes wheels that are capable of being braked by the electric drive via a regenerative braking action with a generator braking torque. Alternatively or additionally, the wheels are capable of being braked by the friction-brake device with a frictional braking torque. A driver and/or an automated driving function can provide, or trip, a braking requirement which gives rise to a braking of the vehicle, of an axle of the vehicle, and/or of one of the wheels with a target braking torque via the electric drive and/or the friction-brake device. According to the braking requirement, the generator braking torque, the frictional braking torque, or an overall braking torque as the sum of the generator braking torque and the frictional braking torque may be required for the purpose of braking.

The selection information is information that is capable of being retrieved and/or captured by the vehicle and that is used for selection of the set of trigger thresholds and of the slip-control method. The selection information can also be ascertained on the basis of data that are capable of being retrieved by the vehicle and/or capable of being captured by the vehicle. The selection information relates, for instance, to a state of the friction-brake device, a state of the electric drive, dynamics of one or more wheels, dynamics of the vehicle, a vehicle state, a property of the roadway, the braking requirement and/or an actuation of the vehicle—that is, requirements in respect of the driving of the vehicle that are different from the braking requirement and that have an influence on the braking: for instance, a setting of a driving mode, an execution of a driving-assistance function, and/or a steering requirement. On the basis of the selection information, in particular the slip-control algorithm is chosen. Consequently, on the basis of the selection information it is chosen whether braking has to be carried out with the friction-brake device, with the electric drive, or with a combination of the friction-brake device and the electric drive.

On the basis of the selection information, the set of trigger thresholds and the slip-control method are ascertained, or selected. A more diverse control of the slip is therefore possible than in the prior art. In particular, incorporating the electric drive into the control of the slip is possible.

The set of trigger thresholds includes one or more threshold-value conditions. The threshold-value conditions relate, in particular, to dynamics of the wheels and/or of the vehicle and can be used for detecting the wheel-locking tendency and/or for controlling the slip. The slip-control method is a routine for controlling the slip. According to the slip-control method, a braking torque is reduced, maintained and/or increased. Such a control of the braking torque may be temporally predetermined and/or dependent on the threshold-value conditions.

On the basis of the slip-control method, or the slip-control algorithm, and the set of trigger thresholds, the instigating of the control of the electric drive and/or of the friction-brake device is undertaken when a wheel-locking tendency has been detected. In this connection, it has been recognized that the electric drive exhibits much higher dynamics and control quality in comparison with the friction-brake device and retarders. It is therefore proposed that when a wheel-locking tendency has been detected the slip-control method and the set of trigger thresholds according to the selection information are used, by which a slip-control method incorporating the electric drive can be taken into account.

In other words, it is proposed to store various trigger thresholds or sets of trigger thresholds for the purpose of detecting a wheel-locking tendency, between which a switch is made during operation, depending on various criteria corresponding to the selection information. On the basis of the selection criterion, a suitable slip-control method can be selected and employed.

A slip-control method can, in particular, instigate a braking action with the aid of the friction-brake device in accordance with an ABS control, a braking action with the aid of the electric drive, and/or a combination thereof. A braking action by a combination of friction-brake device and electric drive is described in patent applications DE 10 2022 123 477.0, DE 10 2022 123 478.9, DE 10 2022 123 479.7, which were not yet published on the date of filing of the present patent application. In this way, it is made possible that the electric drive is not deactivated in the normal case in the course of a comfort braking action and possible recuperation of energy when the classical ABS thresholds are reached, and can instead continue to contribute to the recuperation and active adjustment and/or limitation of the wheel slip.

The selection information preferably includes activity information, the activity information specifying whether the electric drive, which has been configured for regenerative braking, and/or the friction-brake device are/is being operated. The activity information consequently includes information about a state, in particular a present state, of the electric drive and/or of the friction-brake device. A suitable reaction of the overall braking system to a trigger event can therefore occur, taking a currently active actuator or currently active actuators into account. For instance, the friction-brake system may be preferred for the purpose of control if the friction-brake system is already being used for braking. Alternatively or additionally, the electric drive may be preferred for the purpose of controlling the slip if the electric drive is already being used for braking. A control approach can therefore be chosen that is appropriate to a current driving situation, and in this way a braking performance that is suitable in the given case can be provided while maintaining stability, lateral guidance and/or steerability.

The set of trigger thresholds preferably corresponds to a set of trigger thresholds that is different from a set of trigger thresholds for the anti-lock braking system if the activity information specifies that the electric drive which has been configured for regenerative braking is being operated. Otherwise, if the activity information specifies that the electric drive which has been configured for regenerative braking is not being operated, the set of trigger thresholds may correspond to the set of trigger thresholds for the anti-lock braking system. If a braking action is undertaken only with the electric drive, and if the friction-brake device is not active, use may be made of appropriate control thresholds and trigger thresholds optimized for this case. As a result, with the electric drive it is ensured that the wheel slip is limited and the driving stability and driving performance remain guaranteed. In other words, exceeding the classical and/or, in particular, pneumatic ABS control thresholds in the course of a braking action by the electric drive has no impact, because the intervention of the ABS control is unnecessary. The electric drive is not released, and remains active in the course of a braking action in accordance with a set of trigger thresholds defined for the electric drive.

The selection information preferably includes availability information, the availability information relating to an availability and/or to a braking torque of the electric drive which has been configured for regenerative braking. The availability information relates to the electric drive. The availability information specifies whether, and/or to what extent, the electric drive is available for a braking action and/or for an alteration of a braking torque already applied. The availability information may include a binary value that specifies whether the electric drive is available. Alternatively or additionally, the availability information may include a numerical value that specifies, for instance, a control reserve—that is, a braking torque that is potentially capable of being applied at present by the electric drive. The selection information may therefore include exact information with respect to the electric drive, and in this way may result in a suitable selection of the set of trigger thresholds and of the slip-control algorithm.

The set of trigger thresholds preferably corresponds to a set of trigger thresholds for the anti-lock braking system if the availability information specifies that the electric drive which has been configured for regenerative braking is not available. If the electric drive is not available for braking actions at the present time and is unable to furnish a negative torque (braking torque)—for instance, if a state of charge (SOC) of an energy-storage device lies above a defined threshold, if a reduction in torque as a result of temperature derating is indicated, and/or if a system error obtains—the friction-brake device is available, and use is made of the ABS trigger thresholds and control thresholds. An ABS control can be undertaken for the purpose of control.

The selection information preferably includes a braking torque of a braking requirement. The selection information may therefore be dependent on a target braking torque corresponding to the braking requirement.

The selection information preferably includes interaction information that relates to the combined action of the electric drive, which has been configured for regenerative braking, and of the friction-brake device. In this connection, the capability of the electric drive to control the brake slip in interplay with the friction-brake device is incorporated. The interaction information may contain information relating to a degree of integration and/or degree of networking of the electric drive and of the friction-brake device. For instance, the interaction information may define a set of slip-control algorithms, from which a selection is made on the basis of further components of the selection information.

The set of trigger thresholds is preferably ascertained taking into account a set of trigger thresholds for regenerative braking and a set of trigger thresholds for the anti-lock braking system. An appropriate set of trigger thresholds may therefore enter into the ascertaining of the set of trigger thresholds to be used both for the regenerative brake and for the friction-brake device. The set of trigger thresholds for the anti-lock braking system can be selected by the friction-brake device alone at the time of a braking action. Alternatively or additionally, the set of trigger thresholds for regenerative braking can be selected by the electric drive alone at the time of a braking action.

The set of trigger thresholds preferably includes one or more average threshold-value conditions, the one or more average threshold-value conditions being based on a weighted average of a threshold-value condition for regenerative braking pertaining to the set of trigger thresholds for regenerative braking and of a threshold-value condition for the anti-lock braking system pertaining to the set of trigger thresholds for the anti-lock braking system. In the case where networking of the electric drive and of the friction-brake system is present, the wheel slip can be limited, and locking can be prevented, in the case of simultaneous and parallel braking of the electric drive and of the friction-brake device. For this case, a further set of trigger thresholds, or threshold-value conditions, can be determined. In this connection, on the basis of the apportionment of the braking forces on the drive axle to the electric drive and to the friction-brake device it is possible to perform a switch-over or a change-over according to the weighted average among the sets of trigger thresholds for pure frictional braking and for pure regenerative braking.

The average threshold-value condition is preferably dynamically variable. An adaptation of the threshold-value condition can therefore be undertaken in time-dependent manner and can consequently be adapted in accordance with a changing driving situation and/or braking requirement.

According to a further aspect of the disclosure, a computer program and/or computer-readable medium are/is provided. The computer program and/or computer-readable medium include(s) commands that, when the program, or the commands, is/are executed by a computer, induce the latter to carry out the method described herein and/or the steps of the method described herein. The computer program and/or computer-readable medium may include commands, in order to carry out steps of the method that have been described as optional and/or advantageous, in order to achieve an appropriate technical effect.

According to a further aspect of the disclosure, a controller for a vehicle, in particular a commercial vehicle, is provided. The controller has been configured to carry out the method described herein. The controller may have been configured to carry out steps of the method that have been described as optional and/or advantageous, in order to achieve an appropriate technical effect. The controller may be, for instance, a controller of the friction-brake device. Such a controller includes suitable interfaces, in order to be able to receive and/or retrieve data relating to the selection information. Alternatively, the controller may be a controller of the electric drive, and/or may be a central controller.

According to a further aspect of the disclosure, a vehicle, in particular a commercial vehicle, is provided. The vehicle exhibits the controller described herein. The vehicle and/or the controller may have been configured to carry out steps of the method that have been described as optional and/or advantageous, in order to achieve an appropriate technical effect.

### BRIEF DESCRIPTION OF DRAWINGS

The invention will now be described with reference to the drawings wherein:

FIG. 1 shows a schematic representation of an overview of a vehicle, in particular a commercial vehicle, according to an embodiment of the disclosure; and,

FIG. 2 shows a schematic representation of a flowchart of a method according to an embodiment of the disclosure.

### DETAILED DESCRIPTION

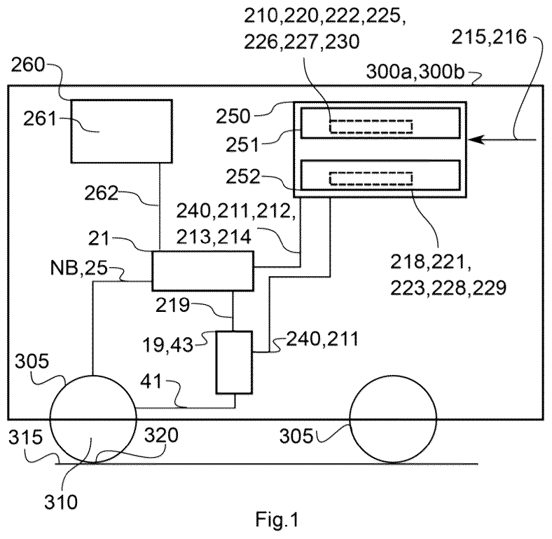

FIG. 1 shows a schematic representation of an overview of a vehicle 300a, in particular a commercial vehicle 300b, according to an embodiment of the disclosure.

The vehicle 300a, in particular the commercial vehicle 300b, will be designated in the following as “vehicle 300a, 300b”. The vehicle 300a, 300b is a land vehicle and is, for instance, a truck, a bus, a trailer and/or a multi-membered vehicle.

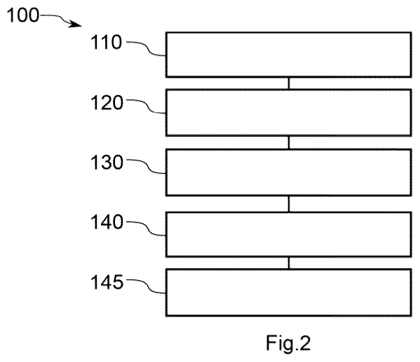

The vehicle 300a, 300b has been configured to carry out the method 100 described with reference to FIG. 2. For this purpose, in the embodiment shown in FIG. 1 the vehicle 300a, 300b exhibits an electric drive 21, a controller 250, a friction-brake device 19 and an energy-storage device 260.

The electric drive 21 has been configured for regenerative braking NB. The electric drive 21 is able to generate a generator braking torque 25 which may result in a deceleration of the vehicle 300a, 300b. The electric drive 21 can bring about an alteration, in particular a reduction and a boost, of the generator braking torque 25.

The friction-brake device 19 is an electric braking system 43, or an electronically controlled braking system, and is able to apply a frictional braking torque 41. In an embodiment which is not shown, the friction-brake device 19 is a pneumatic and/or hydraulic braking system.

The electric drive 21 and the friction-brake device 19 are capable of being operated and controlled separately from one another and/or jointly. The electric drive 21 and the friction-brake device 19 are therefore characterized by a combined action 219 of the electric drive 21 and of the friction-brake device 19. The combined action 219 is described by interaction information 218. The interaction information 218 includes, for instance, particulars as to whether and how the electric drive 21 and the friction-brake device 19 can be controlled jointly.

The vehicle 300a, 300b according to FIG. 1 exhibits several wheels 305. The wheels 305 are arranged on a roadway 315. An overall braking torque 320 imparted by the roadway 315 and brought about by the electric drive 21 and the friction-brake device 19 is able to act on each of the wheels 305. The overall braking torque 320 is the sum of the generator braking torque 25 and the frictional braking torque 41. The roadway 315 may, in particular, be subject to local changes. The roadway 315 may, for instance, exhibit undersurfaces that are different from one another at different places, and may accordingly result in different coefficients of friction. The decelerating of the wheel 305 on the basis of the overall braking torque 320 may have the consequence that the wheel 305 has a tendency to lock. A wheel-locking tendency 310 can consequently be assigned to the wheel 305. The wheel-locking tendency 310 results, for instance, from a slip and/or from an acceleration of the wheel 305.

The electric drive 21 may have been configured, as a so-called central drive, to apply the generator braking torque 320 to several wheels 305 of an axle (not shown). In the embodiment shown in FIG. 1, the electric drive 21 has been configured to apply the generator braking torque 320 individually to each wheel, in which connection FIG. 1 illustrates the braking of a wheel 305 only schematically.

The dynamics of each of the wheels 305 can be characterized by a measurable wheel acceleration, or wheel deceleration, and/or by a temporal change in the wheel acceleration. The wheel deceleration and/or the temporal change in the wheel acceleration can be captured by measured values recorded by a wheel-speed sensor (not shown) and/or by control information 240 pertaining to the electric drive 21. By virtue of the overall braking torque 320 acting, a slip arises between the wheel 305 and the roadway 315. The slip can be ascertained via wheel speeds, for instance.

The electric drive 21 may have been configured to carry out the method for estimating the coefficient of friction that is described in German patent application 10 2022 114 084.9 dated 3 Jun. 2022, which at the time of this application was not yet published. For this purpose, the electric drive may have been configured to carry out an application of a temporally predetermined excitation torque to the wheel 305, the application of the excitation torque to the wheel 305 being undertaken periodically with a frequency; and to carry out therefrom an ascertainment of a change in slip as a function of the excitation torque, the ascertainment of the change in slip being undertaken taking the frequency into account. The coefficient of friction is a property of the roadway.

The energy-storage device 260 has been configured to store and to provide electrical energy 262. For this purpose, the energy-storage device 260 is connected to the electric drive 21. The energy-storage device 260 exhibits a plurality of battery cells and a battery controller (not shown). The energy-storage device 260 has a state of charge 261 which can be increased via regenerative braking NB, and decreased via a drive.

The controller 250 has been configured to receive and to evaluate a braking requirement 216 for braking the vehicle 300a, 300b with a braking torque 215. The braking requirement 216 may include a signal-tripped, for instance, by a pedal actuation and/or by an actuation of a retarder lever by a driver of the vehicle 300a, 300b and/or by an automated driving function-which is transmitted to the controller 250, for instance via a vehicle bus (not shown).

The controller 250 has been configured to receive the control information 240 from the friction-brake device 19 and/or from the electric drive 21. The control information 210 may, in particular, include information relating to dynamics of the vehicle 300a, 300b and/or relating to a wheel 305 of the vehicle 300a, 300b. For this purpose, the controller 250 is connected to the electric drive 21 and to the friction-brake device 19, in order to exchange the control information 240 with the electric drive 21 and with the friction-brake device 19, in particular in order to receive measured values and to send control signals. The electric drive 21 and the friction-brake device 19 send respective activity information 211 to the controller 250, the activity information 211 specifying whether the electric drive 21, which has been configured for regenerative braking NB, and/or the friction-brake device 19 are/is being operated. The electric drive 21 sends availability information 212 to the controller 250, the availability information 212 relating to an availability 213 and/or to a braking torque 214 of the electric drive 21 which has been configured for regenerative braking NB.

The controller 250 has been configured to receive selection information 210 (see description relating to FIG. 2) and/or to ascertain the selection information 210 on the basis of the received control information 240. For this purpose, the controller 250 shown in FIG. 1 includes a processor 251 and a memory 252, in order to process and to store information. The controller 250 has therefore been configured to carry out the steps, described in FIG. 2, of the method 100. In particular, as illustrated schematically in FIG. 1, the interaction information 218, a set of trigger thresholds 221 for the anti-lock braking system, a set of trigger thresholds 223 for regenerative braking, one or more threshold-value conditions 228 for regenerative braking, and one or more threshold-value conditions 229 for the anti-lock braking system have been stored in the memory 252. The processor 251 has been configured to ascertain, on the basis of the data stored in the memory 252 and on the basis of the selection information 210 for the control 145 of the electric drive 21 and/or of the friction-brake device 19, a set of trigger thresholds 220, a set of trigger thresholds 222 that is different from the set of trigger thresholds 221 for the anti-lock braking system, a threshold-value condition 225, an average threshold-value condition 226 and/or a weighted average 227, and to select a slip-control method 230 (see description relating to FIG. 2). On the basis of the information ascertained by the controller 250, the controller 250 can communicate the selected slip-control algorithm 230 and control information 240, relating to the associated set of trigger thresholds 220, for the control 145 of the electric drive 21 and of the friction-brake device 19 to the electric drive 21 and to the friction-brake device 19. The electric drive 19 and/or the friction-brake device 19 can consequently carry out a braking of the vehicle 300a, 300b on the basis of the control information 240.

The friction-brake device 19 includes a friction-brake controller, and the electric drive 21 includes a drive controller (neither shown). The controller 250 is connected to the friction-brake controller and to the drive controller, as described with respect to the friction-brake device 19 and the electric drive 21. In the embodiment of the friction-brake device 19 and of the electric drive 21 that is shown, the controller 250 is a separate controller 250 of the vehicle 300a, 300b. Alternatively, in an embodiment which is not shown, it is possible to integrate the controller 250 into the friction-brake controller or into the drive controller. Optionally, an ascertainment 120 of the set of trigger thresholds 220 and of the slip-control algorithm 230 is carried out by the friction-brake controller, since the friction-brake controller typically carries out functions relating to the driving-stability control.

FIG. 2 shows a schematic representation of a flowchart of a method 100 according to an embodiment of the disclosure. The method 100 is a method 100 of control 145 for a vehicle 300a, in particular a commercial vehicle 300b, having an electric drive 21, which has been configured for regenerative braking NB, and a friction-brake device 19. A vehicle 300a, 300b of such a type is shown in FIG. 1. FIG. 2 will be described with reference to FIG. 1.

The method 100 features a capture 110 of selection information 210. For this purpose, the selection information 210 is ascertained by the controller 250 on the basis of information received by the controller 250 and/or, in an embodiment which is not shown, is captured directly as control information 240, for instance by the electric drive 21 and/or by the friction-brake device 19. For this purpose, the selection information 210 includes the activity information 211, the availability information 212, the braking torque 215 of the braking requirement 216, and the interaction information 218.

An ascertainment 120 of the set of trigger thresholds 220 and of the slip-control method 230 is undertaken on the basis of the selection information 210, in which connection the set of trigger thresholds 220 includes one or more threshold-value conditions 225 defined for the purpose of detecting 130 the wheel-locking tendency 310. The selected set of trigger thresholds 220 is therefore used in order to detect the wheel-locking tendency 310.

A detection 130 of the wheel-locking tendency 310 is undertaken on the basis of the one or more threshold-value conditions 225. For this purpose, control information 240 relating to the wheel 305 is evaluated. Depending on the set of trigger thresholds 220, or on the threshold-value conditions 225, the wheel-locking tendency 310 is capable of being detected. For instance, one of the threshold-value conditions 225 may relate to the slip and/or to the deceleration of the wheel 305. If the slip and/or the deceleration exceed(s) a threshold value defined by the threshold-value conditions 225, the wheel-locking tendency 310 has been detected, and a control of the overall braking torque 320 is indicated. Otherwise, if the threshold value is fallen short of, there is no wheel-locking tendency 310, and the control 145 may not occur.

The set of trigger thresholds 220 includes further threshold-value conditions 226 which are used together with the selection of the slip-control method 230 for the control 145 of the electric drive 21 and/or of the friction-brake device 19.

The set of trigger thresholds 220 corresponds to a set of trigger thresholds 222 that is different from a set of trigger thresholds 221 for the anti-lock braking system if the activity information 211 specifies that the electric drive 21 which has been configured for regenerative braking NB is being operated. In this case, a control 145 that is different from the classical ABS has to be undertaken in accordance with a slip-control method 230 that is different from ABS, in order to enable the electric drive 21 to continue to apply the generator braking torque 25. A control 145 of such a type is described in, for instance, DE 10 2022 123 477.0, DE 10 2022 123 478.9, DE 10 2022 123 479.7. In the case where the electric drive 21 alone is contributing to the overall braking torque 320, the control 145 is undertaken in accordance with a set of trigger thresholds 223 for regenerative braking.

The set of trigger thresholds 220 corresponds to a set of trigger thresholds 221 for the anti-lock braking system if the availability information 212 specifies that the electric drive 21 which has been configured for regenerative braking NB is not available. In this case, only the friction-brake device 19 is available. Therefore the set of trigger thresholds 220 according to the classical ABS is chosen. In this case, the control 145 is undertaken in accordance with the set of trigger thresholds 221 for the anti-lock braking system.

If the electric drive 21 and the friction-brake device 19 are contributing to the overall braking torque 320, the set of trigger thresholds 220 is ascertained taking into account a set of trigger thresholds 223 for regenerative braking and a set of trigger thresholds 221 for the anti-lock braking system. The individual threshold-value conditions 226 of the set of trigger thresholds 220 are ascertained. For this purpose, an appropriate threshold-value condition 228 for regenerative braking pertaining to the set of trigger thresholds 223 for regenerative braking and a threshold-value condition 229 for the anti-lock braking system pertaining to the set of trigger thresholds 221 for the anti-lock braking system are drawn upon for the purpose of ascertaining the threshold-value condition 226. Both the threshold-value condition 228 for regenerative braking and the threshold-value condition 229 for the anti-lock braking system have a numerical value, for instance a limiting value for a slip and/or an acceleration of the wheel 305. The numerical values are used in order to calculate an average threshold-value condition 226 according to a weighted average 227 of the threshold-value condition 228 for regenerative braking and the threshold-value condition 229 for the anti-lock braking system pertaining to the set of trigger thresholds 221 for the anti-lock braking system. By virtue of the weighted average 227, the threshold-value condition 228 for regenerative braking and the threshold-value condition 229 for the anti-lock braking system optionally enter differently into the average threshold-value condition 226. The threshold-value condition 226 can therefore be continuously changed over between the threshold-value condition 228 for regenerative braking and the threshold-value condition 229 for the anti-lock braking system. The average threshold-value condition 226 is dynamically variable—that is, time-dependent-if the selection information 210 changes in the course of time.

It is therefore possible that if the friction-brake device 19 is currently contributing the largest portion to the retardation on the drive axle the classical pneumatic ABS trigger thresholds can be used and the electric drive 21 is released, for instance in the event of a very strong braking action or if the electric drive 21 is only able to recuperate and brake to a limited extent. If, on the other hand, the electric drive 21 is contributing the largest portion to the overall braking torque 320, a releasing of the electric drive 21 is not indicated and the set of trigger thresholds 223 for regenerative braking is used for pure braking by the electric drive 21.

An instigation 140 of a control 145 of the electric drive 21 and/or of the friction-brake device 19 is undertaken on the basis of the slip-control method 230 and the set of trigger thresholds 220 when a wheel-locking tendency 310 has been detected. For this purpose, the controller 250 can output corresponding control information 240 to the electric drive 21 and/or to the friction-brake device 19, the control 145, or altering, of the braking torque being undertaken in accordance with the control information 240 by the electric drive 21 and/or by the friction-brake device 19.

It is understood that the foregoing description is that of the preferred embodiments of the invention and that various changes and modifications may be made thereto without departing from the spirit and scope of the invention as defined in the appended claims.

### REFERENCE SYMBOLS (PART OF THE DESCRIPTION)

19 friction-brake device
21 electric drive
25 generator braking torque
41 frictional braking torque
43 electric braking system
100 method
110 capture
120 ascertainment
130 detection
140 instigation
145 control
210 selection information
211 activity information
212 availability information
213 availability
214 braking torque of the electric drive
215 braking torque of a braking requirement
216 braking requirement
218 interaction information
219 combined action
220 set of trigger thresholds
221 set of trigger thresholds for the anti-lock braking system
222 set of trigger thresholds
223 set of trigger thresholds for regenerative braking
225 threshold-value condition
226 average threshold-value condition
227 weighted average
228 threshold-value condition for regenerative braking
229 threshold-value condition for the anti-lock braking system
230 slip-control method
240 control information
250 controller
251 processor
252 memory
260 energy-storage device
261 state of charge
262 electrical energy
300a vehicle
300b commercial vehicle
305 wheel
310 wheel-locking tendency
315 roadway
320 overall braking torque
NB regenerative braking

1. A method of control for a vehicle, the vehicle having an electric drive configured for regenerative braking and a friction-brake device, the method comprising:
capturing selection information;
ascertaining a set of trigger thresholds and a slip-control method on a basis of the selection information, the set of trigger thresholds including one or more threshold-value conditions defined for detecting a wheel-locking tendency;
detecting the wheel-locking tendency on a basis of the one or more threshold-value conditions; and,
instigating a control of at least one of the electric drive and the friction-brake device on a basis of the slip-control method and the set of trigger thresholds when the wheel-locking tendency has been detected.

2. The method of claim 1, wherein the selection information includes activity information, the activity information specifying whether at least one of the electric drive, which has been configured for regenerative braking, and the friction-brake device is being operated.

3. The method of claim 2, wherein the set of trigger thresholds corresponds to a set of trigger thresholds that is different from a set of trigger thresholds for an anti-lock braking system if the activity information specifies that the electric drive configured for regenerative braking is being operated.

4. The method of claim 1, wherein the selection information includes availability information, the availability information relating to at least one of an availability and a braking torque of the electric drive configured for regenerative braking.

5. The method of claim 4, wherein the set of trigger thresholds corresponds to a set of trigger thresholds for an anti-lock braking system if the availability information specifies that the electric drive configured for regenerative braking is not available.

6. The method of claim 1, wherein the selection information includes a braking torque of a braking requirement.

7. The method of claim 1, wherein the selection information includes interaction information that relates to a combined action of the electric drive configured for regenerative braking and of the friction-brake device.

8. The method of claim 7, wherein the set of trigger thresholds is ascertained taking into account a set of trigger thresholds for regenerative braking and a set of trigger thresholds for an anti-lock braking system.

9. The method of claim 8, wherein the set of trigger thresholds includes one or more average threshold-value conditions, the one or more average threshold-value conditions being based on a weighted average of a threshold-value condition for regenerative braking pertaining to the set of trigger thresholds for regenerative braking and a threshold-value condition for the anti-lock braking system pertaining to the set of trigger thresholds for the anti-lock braking system.

10. The method of claim 9, wherein the average threshold-value condition is dynamically variable.

11. The method of claim 1, wherein the vehicle is a commercial vehicle.

12. A computer program comprising:
program code for controlling a vehicle having an electric drive configured for regenerative braking, said program code being stored on a non-transitory computer readable medium; and,
said program code being configured, when executed by a processor, to perform the method of claim 1.

13. A computer readable medium comprising:
a non-transitory computer readable storage medium having program code for controlling a vehicle having an electric drive configured for regenerative braking stored thereon; and,
said program code being configured, when executed by a processor, to perform the method of claim 1.

14. A controller for a vehicle having an electric drive configured for regenerative braking, the controller comprising:
a processor;
a non-transitory computer readable storage medium having program code for controlling the vehicle having the electric drive configured for regenerative braking stored thereon;
said program code being configured, when executed by said processor, to:
capture selection information;
ascertain a set of trigger thresholds and a slip-control method on a basis of the selection information, the set of trigger thresholds including one or more threshold-value conditions defined for detecting a wheel-locking tendency;
detect the wheel-locking tendency on a basis of the one or more threshold-value conditions; and,
instigate a control of at least one of the electric drive and the friction-brake device on a basis of the slip-control method and the set of trigger thresholds when a wheel-locking tendency has been detected.

15. The controller of claim 14, wherein the vehicle is a commercial vehicle.

16. A vehicle comprising:
an electric drive configured for regenerative braking;
a controller including a processor and a non-transitory computer readable storage medium having program code for controlling the vehicle;
said program code being configured, when executed by said processor, to:
capture selection information;
ascertain a set of trigger thresholds and a slip-control method on a basis of the selection information, the set of trigger thresholds including one or more threshold-value conditions defined for detecting a wheel-locking tendency;
detect the wheel-locking tendency on a basis of the one or more threshold-value conditions; and,
instigate a control of at least one of the electric drive and the friction-brake device on a basis of the slip-control method and the set of trigger thresholds when the wheel-locking tendency has been detected.

17. The vehicle of claim 16, wherein the vehicle is a commercial vehicle.
